(19) United States
(12) Patent Application Publication
(10) Pub. No.: US 2023/0265268 A1
(43) Pub. Date: Aug. 24, 2023

(54) THERMOPLASTIC ELASTOMER COMPOSITION

(71) Applicant: Polymax TPE LLC, Waukegan, IL (US)

(72) Inventors: Yun Martin LU, Waukegan, IL (US); Xin ZHANG, Waukegan, IL (US); Xiaofeng ZHENG, Waukegan, IL (US); Qianqian LI, Waukegan, IL (US)

(21) Appl. No.: 18/296,994

(22) Filed: Apr. 7, 2023

Related U.S. Application Data
(63) Continuation-in-part of application No. 17/889,327, filed on Aug. 16, 2022.
Application No. 17/889,327 is a continuation of application No. 16/855,888, filed on Apr. 22, 2020, now Pat. No. 11,447,619.
(60) Provisional application No. 62/837,168, filed on Apr. 22, 2019.

(51) Int. Cl. C08L 23/06; C08L 53/00; C08L 91/00; C08K 5/00

(52) U.S. Cl. CPC C08L 23/06; C08L 53/00; C08L 91/00; C08K 5/005; C08L 2205/03; C08L 2207/04; C08L 2207/066

(57) ABSTRACT

A thermoplastic elastomer composition and method of making the thermoplastic elastomer are disclosed. The thermoplastic elastomer may comprise a polymer blend. The polymer bland may comprise at least one bio based component of: a non-crosslinked elastomer, softener, polyethylene, and polar polymer. The softener may be from about 15 wt. % to about 50 wt. % softener. The polyethylene may be from about 3 wt. % to about 30 wt. %. The polar polymer may be from about 3.0 to about 15 wt. %.

### RELATED PATENT APPLICATIONS

This application is a continuation-in-part of and claims priority of U.S. non-provisional patent application Ser. No. 17/889,327, which was filed on Aug. 16, 2022, which claims priority of non-provisional patent application Ser. No. 16/855,888, which was filed on Apr. 22, 2020, which claims priority of provisional application No. 62/837,168, which was filed on Apr. 22, 2019. The entire disclosures of which are incorporated by reference herein.

### TECHNICAL FIELD

The present disclosure relates generally to thermoplastic elastomeric compositions and more specifically to thermoplastic elastomeric compositions with low compression set and good melt strength using bio-based raw materials and recycled materials for better sustainability and higher surface energy and improvement of the compound's ink adhesion.

### BACKGROUND

A problem that is becoming more evident these days within the wine industry is that a great number of traditionally naturally sealed wines are damaged by cork that is tainted, ill-fitting or deteriorated.

It is estimated that around 5-10% of all wines have been be affected to some degree and in some cases the wine will have to be discarded because the cork is “corked”, meaning that the porous and imperfect material (wood bark) was tainted or infected, and during its contact with the wine, it altered its chemistry with damaging results to the quality of the wine. The “corked wine” will be affected and depending of the seriousness of the taint, it could show symptoms that go from musty smell, to a change in the tastes of the wine, which becomes flat and bodiless.

Therefore, there is a need to develop synthetic wine cork with elastomeric materials that have low compression set and good melt strength. Additionally, there is a need to develop high performance thermoplastic elastomer composition having bio based or biorenewable or recycled components with excellent elastity, low compression set and desirable oil stability.

### SUMMARY

According to a first aspect, the thermoplastic elastomer may comprise a polymer blend. The polymer blend may comprise a non-crosslinked elastomer, softener, polyethylene, and polar polymer. The softener may be from about 15 wt. % to about 50 wt. %. The polyethylene may be from about 3.0 wt. % to about 30 wt. %. The polar polymer may be from about 3.0 wt. % to about 15 wt. %.

In certain aspects, the softener comprises renewably-sourced softener made from plant feedstocks and it may also come from chemically or physically recycled materials.

In certain aspects, the non-crosslinked elastomer may comprise styrenic block copolymer and some or all of the raw monomers to make the styrenic block compolymer can come from renewably-sourced materials. The renewably sourced material could come from plant based feedstocks or chemically recycled materials.

In certain aspects, the styrenic block copolymer may be selected from a group consisting of styrene-ethylene-butadiene-styrene polymer, styrene-ethylene butylene-styrene, styrene-ethylene propylene-styrene (SEPS), hydrogenated styrene farnesene block copolymers (HSFC), hydrogenated polybutadiene, hydrogenated polyisoprene, hydrogenated styrene-isoprene random copolymer, styrene-ethylene propylene (SEP) block copolymer, styrene-ethylene ethylene propylene-styrene (SEEPS), and hydrogenated styrene-butadiene random copolymer.

In certain aspects, the styrenic block copolymer may comprise styrene-ethylene-butylene-styrene polymer.

In certain aspects, the styrenic block copolymer may comprise about 20 wt. % to about 50 wt. % styrene-ethylene-butylene-styrene polymer.

In certain aspects, the styrene-ethylene-butylene-styrene polymer total molecular weight is from 100,000 to 440,000 g/mol.

In certain aspects, the renewably-sourced softener made from plant feedstocks or more from chemically recycled materials may comprise paraffinic softener. It may also comprise an ethylene/α-olefin oligomer made ether from petroleum based or renewably-sourced or chemically or physically recycled materials.

In certain aspects, the styrene-ethylene-butylene-styrene polymer total molecular weight is from 200,000 g/mol to 440,000 g/mol.

In certain aspects, the polyethylene may comprise material made from renewably-sourced or chemically recycled monomers. It could also be post consumer, or post industrial recycled materials. It may comprise Linear low density polyethylene, Low density polyethylene or High density polyethylene.

In certain aspects, the styrene-ethylene-butylene-styrene polymer total molecular weight is from 240,000 g/mol to 440,000 g/mol. In certain aspects, linear low density polyethylene has melt flow index of about 0.5 to about 10.0 g/10 min, measured at 190° C., employing 2.16 kilogram (kg) weight.

In certain aspects, the thermoplastic elastomer has Shore A hardness from about 30 to 95A.

In certain aspects, the thermoplastic elastomer has a weight percent ratio of non-crosslinked elastomer to softener, when present, from about 0.4 to about 2.5.

In certain aspects, the weight percent ratio is from about 0.7 to about 1.5.

In certain aspects, the thermoplastic elastomer has melt viscosity at shear rate of 67 1/s of about 200 to about 2000 Pa·s, measured at 200° C.

In certain aspects, the thermoplastic elastomer has melt viscosity at shear rate of 67 1/s of about 500 to about 1300 Pa·s, measured at 200° C.

In certain aspects, the thermoplastic elastomer has melt viscosity at shear rate of 67 1/s of about 200 to about 500 Pa·s, measured at 200° C.

In certain aspects, the thermoplastic elastomer has melt viscosity at shear rate of 67 1/s of about 700 to about 1100 Pa·s, measured at 200° C.

In certain aspects, the non-crosslinked elastomer total molecular weight is from about 100,000 to about 440,000 g/mol.

In certain aspects, the non-crosslinked elastomer total molecular weight is from about 200,000 to about 400,000 g/mol.

According to a second aspect, a thermoplastic elastomer may comprise a polymer blend. The polymer blend may comprise a styrenic block copolymer, softener, polyethylene, and filler. The softener may be from about 15 wt. % to about 50 wt. %. The polyethylene may be from about 5 wt. % to about 30 wt. %. The filler may be from about 3.0 to about 20 wt. %. The thermoplastic elastomer may have melt viscosity at shear rate of 67 1/s of about 200 to about 2000 measured at about 200° C.

The styrenic block copolymer may be selected from a group consisting of styrene-ethylene-butylene-styrene polymer, styrene-ethylene butylene-styrene, styrene-ethylene propylene-styrene (SEPS), hydrogenated styrene farnesene block copolymers (HSFC), styrene-ethylene propylene (SEP) block copolymer, styrene-ethylene ethylene propylene-styrene (SEEPS), and hydrogenated styrene-butadiene random copolymer.

According to a third aspect, a thermoplastic elastomer may comprise a polymer blend. The polymer blend may comprise a biobased styrenic block copolymer, softener, polyethylene, a polar polymer. The softener may be from about 15 wt. % to about 50 wt. %. The polyethylene may be from about 3 wt. % to about 30 wt. %. The anti-oxidant may be from about 3.0 to about 15 wt. % a polar polymer. the thermoplastic elastomer has a weight percent ratio of styrenic block copolymer to softener, when present, from about 0.4 to about 2.5.

The styrenic block copolymer may be selected from a group consisting of styrene-ethylene-butylene-styrene polymer, styrene-ethylene butylene-styrene, styrene-ethylene propylene-styrene (SEPS), hydrogenated styrene farnesene block copolymers (HSFC), styrene-ethylene propylene (SEP) block copolymer, styrene-ethylene ethylene propylene-styrene (SEEPS), and hydrogenated styrene-butadiene random copolymer.

### DETAILED DESCRIPTION

In the following description, well-known functions or constructions are not described in detail because they may obscure the disclosure in unnecessary detail. For this disclosure, the following terms and definitions shall apply.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Additionally, variations to the disclosed embodiments can be understood and effected by the skilled person in practicing the claimed disclosure, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

Also, two or more steps may be performed concurrently or with partial concurrence. Further, the steps of the method may be performed in an order different from what has been disclosed. Such variation will depend on the process hardware systems chosen and on designer choice. All such variations are within the scope of the disclosure. Additionally, even though the disclosure has been described with reference to specific exemplifying embodiments thereof, many different alterations, modifications and the like will become apparent for those skilled in the art.

Embodiments include thermoplastic elastomeric material compositions, processes for preparing the compositions and articles of manufacture prepared from the compositions. In one embodiment, the thermoplastic elastomeric composition is provided comprising a polymer blend of about 15% to about 50% styrene-ethylene-butadiene-styrene (SEBS) polymer; from about 15% to about 50% softener; from about 3.0% to about 30% polyethylene; and from about 0 to about 0.5% anti-oxidant.

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers. For example, the term “copolymer” includes the copolymerization reaction product of ethylene and an alpha-olefin, such as 1-hexene. However, the term “copolymer” is also inclusive of, for example, the copolymerization of a mixture of ethylene, propylene, 1-hexene, and 1-octene.

As used herein, when a polymer is referred to as “comprising a monomer,” the monomer is present in the polymer in the polymerized form of the monomer or in the derivative form the monomer.

As used herein, “molecular weight” means weight average molecular weight (“Mw”). Mw is determined using Gel Permeation Chromatography. Molecular Weight Distribution (“MWD”) may be defined or measured as Mw divided by number average molecular weight (“Mn”). (For more information, see U.S. Pat. No. 4,540,753 to Cozewith et al. and references cited therein, and in Ver Strate et al., 21 MACROMOLECULES, pp. 3360-3371 (1998)). The “Mz” value is the high average molecular weight value, calculated as discussed by A. R. Cooper in Concise Encyclopedia of Polymer Science and Engineering, pp. 638-639 (J. I. Kroschwitz, ed. John Wiley & Sons 1990).

The term “active agent” refers to a substance capable of delivering special activity or function to users. Suitable active agents may be in a variety of geometric forms including discrete particles, fibers, flakes, rods, spheres, needles, particles coated with fibers and the like.

The term “compression” refers to the process or result of pressing by applying a force on an object, thereby increasing the density of the object.

The terms “elastomeric,” “elastomer,” “elastic,” and other derivatives of “elastomeric” are used interchangeably and refer to materials having elastomeric or rubbery properties. Elastomeric materials, such as thermoplastic elastomers and thermoplastic vulcanizates, are generally capable of recovering their shape after deformation when the deforming force is removed. Specifically, as used herein, elastomeric is meant to be that property of any material which upon application of an elongating force, permits that material to be stretchable to a stretched length which is at least about 25 percent greater than its relaxed length, and that will cause the material to recover at least 40 percent of its elongation upon release of the stretching elongating force. A hypothetical example which would satisfy this definition of an elastomeric material in the X-Y planar dimensions would be a one (1) inch sample of a material which is elongatable to at least 1.25 inches and which, upon being elongated to 1.25 inches and released, will recover to a length of not more than 1.15 inches. Many elastomeric materials may be stretched by much more than 25 percent of their relaxed length, and can recover to substantially their original relaxed length upon release of the stretching, elongating force. In addition to a material being elastomeric in the described X-Y planar dimensions of a structure, including a web or sheet, the material can be elastomeric in the Z planar dimension. Specifically, when a structure is compressively loaded, it displays elastomeric properties and will essentially recover to its original position upon removal of the load. Compression set is sometimes used to help describe such elastic recovery. When compression is applied to an elastomeric structure, the structure may display elastomeric properties and then recover to near its original position upon relaxation.

The term “extensible” refers to a material that is generally capable of being extended or otherwise deformed, but which does not recover a significant portion of its shape after the extension or deforming force is removed.

The term “flexible” refers to the ability of a material to bend under an imposed load such that its Bending Modulus at 0.5 mm deflection is 1000 g/mm or lower as measured by the Bending Modulus Test.

The term “thermoplastic” describes a material that softens and/or flows when exposed to heat and which substantially returns to its original hardened condition when cooled to room temperature.

As used herein, “weight percent” or “wt. %”, unless noted otherwise, means a percent by weight of a particular component based on the total weight of the composition containing the component. For example, if a mixture contains three pounds of sand and one pound of sugar, then the sand comprises 75 wt. % (3 lbs. sand/4 lbs. total mixture) of the mixture and the sugar 25 wt. %.

The term “crystalline” if employed, refers to a polymer or a segment that possesses a first order transition or crystalline melting point (Tm) as determined by differential scanning calorimetry (DSC) or equivalent technique. The term may be used interchangeably with the term “semicrystalline‘. The term “amorphous” refers to a polymer lacking a crystalline melting point as determined by differential scanning calorimetry (DSC) or equivalent technique.

As used herein, Melt Flow Rates (“MFR”) may be determined in accordance with ASTM D1238 at 230° C. and 2.16 kg weight.

As used herein, Melt Indices (“MI”) or Melt Flow Index/Indices, also may be known as Melt Flow Rates, which may be determined in accordance with ASTM D1238 at 190° C. and 2.16 kg weight.

Unless otherwise indicated, all numbers expressing quantities of ingredients, properties such as molecular weight, reaction conditions, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of reported significant digits and by applying ordinary rounding techniques.

Notwithstanding that the numerical ranges and parameters set forth the broad scope of the invention are approximations, the numerical values set forth in specific examples are reported as precisely as possible. Any numerical value, however, inherently contain certain errors necessarily resulting from the standard deviation found in their respective testing measures.

The thermoplastic elastomeric compositions may comprise a polymer blend. The polymer blend may comprise a non-crosslinked elastomer, softener, polyethylene, and an antioxidant.

Preferred styrenic block copolymers are those having the formulae: ABA, (A-B) nX, ABAB′ or ABA′B′ respectively, wherein A and A′ represent a poly (monovinyl aromatic) block and B and B′ represent hydrogenated poly (conjugated diene(s)) blocks, wherein n is an integer≥2 and wherein X is the remainder of a coupling agent. It will be appreciated that the blocks A and A′, and B and B′ respectively are equal or different from each other, in that the blocks A are larger than the blocks A′ and the blocks B are larger than B′ or B and B′ are equal.

Most preferred block copolymers have the formulae ABA or (A-B)nX, wherein A represents a polymer block of one or more monovinyl aromatic monomers selected from styrene, C1-C4 alkyl styrene and C1-C4dialkylstyrene and in particular styrene, α-methyl styrene, o-methyl styrene or p-methyl styrene, 1,3-dimethylstyrene, p-tert-butyl styrene or mixtures thereof and most preferably styrene only, wherein B represents a polymer block of one or more conjugated diene monomers containing from 4 to 8 carbon atoms, such as 1,3-butadiene, 2-methyl-1,3-butadiene (isoprene), 2,3-dimethyl-1,3-butadiene or mixtures thereof, and preferably butadiene or isoprene and most preferably butadiene.

Preferred block copolymers ABA or (A-B)ₙX comprise substantially pure poly(styrene) blocks, each having a true molecular weight in the range of from 3 kg/mole to 50 kg/mole while the total apparent molecular weight is in the range of from 70 to 700 kg/mol and preferably from 100 to 500 kg/mol. The molecular weights referred to in this specification and claims can be measured with gel permeation chromatography (GPC) using polystyrene calibration standards, such as is done according to ASTM 3536. GPC is a well-known method wherein polymers are separated according to molecular size, the largest molecule eluting first. The chromatograph is calibrated using commercially available polystyrene molecular weight standards. The molecular weight of polymers measured using GPC so calibrated are apparent molecular weights, also known as styrene equivalent molecular weights. The styrenic equivalent molecular weight may be converted to true molecular weight when the styrenic content of the polymer and the vinyl content of the diene segments are known. The detector used is preferably a combination ultraviolet and refractive index detector. The molecular weights expressed herein are measured at the peak of the GPC trace, converted to true molecular weights, and are commonly referred to as “peak molecular weights”.

Preparation methods for such polymers may be found in U.S. Pat. Nos. 3,231,635, 3,231,635, 3,231,635, 3,231,635, and 3,231,635, in U.S. Pat. Nos. 3,231,635, 3,231,635. 3,231,635. and in U.S. Pat. No. 3,231,635. Processes for the selective hydrogenation of the B blocks were known from e.g. U.S. Pat. No. 3,231,635. U.S. Pat. No. 3,231,635. U.S. Pat. No. 3,231,635. U.S. Pat. Nos. 3,231,635, and 3,231,635. Suitable representatives of said most preferred block copolymers are those available under the trade names KRATON®, SEPTON™ and TUFTEC™, Kraton CirKular+™ ReNew, SEPTON™ BIO.

For instance KRATON G 1650, KRATON G 1654, KRATON G 1651, KRATON G 1652, KRATON G 1633, KRATON G 1641, KRATON G 1657, KRATON A 1535, KRATON A 1636, KRATON GRP 6924, Kraton Cirkular+ReNew R1651, R1654, SEPTON 4055, SEPTON 4077, TUFTEC H 1272, SEPTON BIO SF903, SEPTON BIO SF902, SEPTON BIO SF904, TSRC Taipol 6150, Taipol 6154, Taipol 6151, Taipol 6159, Sinopec 503T, 602T and 604T comprising usually poly(conjugated diene) blocks being hydrogenated until less than 10% of the original ethylenic unsaturation.

The block copolymers that may be used in this embodiment may be selected from the group of styrene-ethylene butylene-styrene (SEBS), hydrogenated styrene farnesene block copolymers (HSFC), styrene-ethylene propylene-styrene (SEPS), hydrogenated polybutadiene, hydrogenated polyisoprene, hydrogenated styrene-isoprene random copolymer, styrene-ethylene propylene (SEP) block copolymer, styrene-ethylene ethylene propylene-styrene (SEEPS) and hydrogenated styrene-butadiene random copolymer.

The hydrogenation of random diene copolymers are described by authors E. W. Duck, J. R. Hawkins, and J. M. Locke, in Journal of the IRI, 6, 19, 1972, which may be used as the highly saturated elastomer in this invention. The saturated triblock polymers, SEBS and SEPS, with styrenic end blocks are also used in this invention as the saturated elastomers. SEBS and SEPS are obtained on the hydrogenation of triblock copolymers of styrenic and butadiene or styrenic and isoprene and are known to be commercially available. Some commercially available examples of such elastomers include Kraton G series polymers. U. S. Pat. No. 3, 686, 364 and U. S. Pat. No. 3, 865, 776 give some examples of block copolymers that may be used in the practice of this invention. It is highly preferred that the highly saturated elastomer be SEBS having a bound styrenic content that is within the range of 15 weight percent to about 60 weight percent.

It is possible to use the saturated block copolymers that are modified versions of SEBS. Such modified block copolymers additionally have a substantial number of styrenic units that are randomly distributed in the rubber mid blocks of ethylene and butylene. These modified saturated block copolymers are supplied under Kraton ‘A’ series. Saturated block copolymers grades as mentioned in TPE 2003 RAPRA Conference Proceedings, Brussels, Belgium, Sep. 16-17, 2003, Paper 18, Page 157, and Paper 21, page 181 may also be used.

In one embodiment, polystyrene-ethylene-butadiene-styrene (SEBS) block copolymer may include suitable SEBS copolymers that include those with a block styrenic content of about 10 to about 40 wt. % based on the total SEBS copolymer, and have Shore A hardness values of about 40 to about 85.

The thermoplastic elastomeric may comprise about 0.1 wt. % to about 40 wt. % polyethylene, more preferably about 1.0 wt. % to about 35 wt. % polyethylene, more preferably 3.0 wt. % to about 30 wt. % polyethylene, more preferably, 4.0 wt. % to about 25 wt. % polyethylene. Suitable polyethylene may include high density polyethylene (HDPE), low density polyethylene (LDPE), and linear low density polyethylene (LLDPE). In one embodiment, high molecular weight polyethylene compounds may be used. In one embodiment, suitable linear low density polyethylene (LLDP) generally have melt indices of about 0.5 to about 10.0 g/10 min, measured at 190° C., employing 2.16 kilogram (kg) weight. Suitable polyethylene may also include these that some or all of the monomers are from renewable sources.

The thermoplastic elastomeric compositions may comprise up to about 60% wt. %, preferably about 15 wt. % to about 55 wt. % softener, more preferably about 15 wt. % to about 50 wt. % softener, for example. Suitable softener may include renewably-sourced softener. Suitable softener may include paraffinic oils (ASTM D2226 TYPE 104), or naphthenic oils (ASTM 103 & 104A) or an ethylene/α-olefin oligomer.

Biorenewable Components

A) Softener

As indicated hereinabove, one of the biorenewable components is a softener preferably an oil, e.g. natural oil, such as an ester group-containing oil, such as a monoester, diester, or triester. As defined in the art, an ester comprises the formula R—COO—R¹, wherein R is hydrogen or a hydrocarbyl and R¹ is a hydrocarbyl, e.g. an alkyl, aryl, or alkyl aryl, each optionally substituted.

In one preferred embodiment, the biorenewable softener component comprises a glyceride or acylglycerol, i.e. a monoglyceride, diglyceride, triglyceride, or combination thereof. Many naturally occurring fats and oils are the fatty acid esters of glycerol. Triglycerides are preferred in one embodiment. The glycerides can be saturated or unsaturated or a combination thereof. The styrenic block copolymers having a controlled distribution copolymer block including a conjugated diene and a mono alkenyl arene are less polar than a styrenic block copolymer containing a random conjugated diene and mono alkenyl arene block. Thus, it is expected that such block copolymers are miscible with standard mineral or white oil. However, it was surprisingly discovered that such controlled distribution copolymer block-containing styrenic block copolymers can be formulated with relatively high amounts of biorenewable softeners.

One or more esters can be employed in the present invention. In a preferred embodiment at least one ester utilized is biorenewable. Suitable esters that can be employed in the present invention include those of the following formulas:

(R₁—COO—)ₙ—R₂ and (R₁—OCO—)ₙ—R₂

where n has any value from 1 to about 8, and R₁ and R₂ are the same or different and are hydrogen or a hydrocarbyl (including substituted hydrocarbyls) provided the ester is compatible in the compositions of the invention. It is noted that a suitable group for R₂ depends on the value of n.

In one embodiment of the present invention, n is 1, and the ester has the formula RiC(O)OR₂ where R₁ is a C10-C22, preferably a C15-C22, alkyl, and R₂ is a lower alkyl radical containing from 1 to 22 carbon atoms. R₁ is preferably C13 or more when SEEPS is present in a composition.

Another class of suitable esters that may be employed in the present invention is represented by the following formula:

R₁—COO—R₃—OH

Still another class of suitable esters that may be employed in the present invention is represented by the following formula:

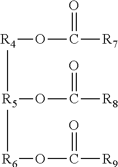

where R₄, R₅, and R₆ individually include alkylene or substituted alkylene; and R₇, R₈, and R₉ individually include hydrogen or a hydrocarbyl.

Suitable esters of the type mentioned above are eicosyl erucate ester or a C12-C15 alkyl octanoate. Examples of other suitable esters include, but are not limited to: acetylline methylsilanol mannuronate; acetaminosalol; acetylated cetyl hydroxyprolinate; acetylated glycol stearate; acetylated sucrose distearate; acetylmethionyl methylsilanol elastinate; acetyl tributyl citrate; acetyl triethyl citrate; acetyl trihexyl citrate; aleurites moluccana ethyl ester; allethrins; allyl caproate; amyl acetate; arachidyl behenate; arachidyl glycol isostearate; arachidyl propionate; ascorbyl dipalmitate; ascorbyl palmitate; ascorbyl stearate; aspartame; batyl isostearate; batyl stearate; bean palmitate; behenyl beeswax; behenyl behenate; behenyl erucate; behenyl isostearate; behenyl/isostearyl beeswax; Borago officinalis ethyl ester; butoxyethyl acetate; butoxyethyl nicotinate; butoxyethyl stearate; butyl acetate; butyl acetyl ricinoleate; 2-t-butylcyclohexyl acetate; butylene glycol dicaprylate/dicaprate; butylene glycol montanate; butyl ester of ethylene/MA copolymer; butyl ester of PVNI copolymer; butylglucoside caprate; butyl isostearate; butyl lactate; butyl methacrylate; butyl myristate; butyloctyl beeswax; butyloctyl candelillate; butyloctyl oleate; butyl oleate; butyl PABA; butylparaben; butyl stearate; butyl thioglycolate; butyroyl trihexyl citrate; C18-C36 acid glycol ester; C12-C20 acid PEG-8 ester; calcium stearoyl lactylate; C18-28 alkyl acetate; C18-C38 alkyl beeswax; C30-50 alkyl beeswax; C20-C40 alkyl behenate; C18-C38 alkyl C24-54 acid ester; C8 alkyl ethyl phosphate; C18-38 alkyl hydroxystearoyl stearate; C12-13 alkyl lactate; C12-15 alkyl lactate; C12-13 alkyl octanoate; C12-15 alkyl octanoate; C18-36 alkyl stearate; C₂₀₋₄o alkyl stearate; C30-50 alkylstearate; C₄₀₋₆₀ alkyl stearate; caproyl ethyl glucoside; caprylyl butyrate; C10-30 cholesterol/lanoster-ol esters; cellulose acetate; cellulose acetate butyrate; cellulose acetate propionate; cellulose acetate propionate carboxylate; Ceteareth-7 stearate; cetearyl behenate; cetearyl candelillate; cetearyl isononanoate; cetearyl octanoate; cetearyl palmitate; cetearyl stearate; cetyl acetate; acetyl ricinoleate; cetyl caprylate; cetyl Ci₂₋isParath-9 carboxylate; cetyl glycol isostearate; cetyl isononanoate; cetyl lactate; cetyl laurate; cetyl myristate; cetyl octanoate; cetyl oleate; cetyl palmitalte; cetyl PCA; cetyl PPG-2 lsodeceth-7 carboxylate; cetyl ricinoleate; cetyl stearate; C16-20 glycol isostearate; C20-30 glycol isostearate; C14-16 glycol palmitate; chimyl isostearate; chimyl stearate; cholesteryl acetate; cholesteryl/behenyl/octyldodecyl lauroyl glutamate; cholesteryl butyrate; cinoxate; citronellyl acetate; coco-caprylate/caprate; coco rapeseedate; cocoyl ethyl glucoside; corylus ethyl ester; C12-15 Pareth-9 hydrogenated tallowate; C11-15 Pareth-3 oleate; C12-15 Pareth-12 oleate; C11-15 Pareth-3 stearate; C11-15 Pareth-12 stearate; decyl isostearate; decyl myristate; decyl oleate; decyl succinate; DEDM hydantoin dilaurate; dextrin behenate; dextrin laurate; dextrin myristate; dextrin palmitate; dextrin stearate; diacetin; dibutyl adipate; dibutyl oxalate; dibutyl sebacate; di-C12-15 alkyl adipate; di-C12-15 alkyl fumarate; di-C12-13 alkyl malate; di-C12-13 alkyl tartrate; di-C14-15 alkyl tartrate; dicapryl adipate; dicaprylyl maleate; dicetearyl dimer dilinoleate; dicetyl adipate; dicetyl thiodipropionate; dicocoyl pentaerythrilyl distearyl citrate; diethoxyethyl succinate; diethyl acetyl aspartate; diethylaminoethyl cocoate; diethylaminoethyl PEG-5 cocoate; diethylaminoethyl PEG-5 laurate; diethylaminoethyl stearate; diethyl aspartate; diethylene glycol diisononanoate; diethylene glycol dioctanoate; diethylene glycol dioctanoate/diisononanoate; diethyl glutamate; diethyl oxalate; diethyl palmitoyl aspartate; diethyl sebacate; diethyl succinate; digalloyl trioleate; diglyceryl stearate malate; dihexyl adipate; dihexyldecyl lauroyl glutamate; dihydroabietyl behenate; dihydroabietyl methacrylate; dihydrocholesteryl butyrate; dihydrocholesteryl isostearate; dihydrocholesteryl macadamiate; dihydrocholesteryl nonanoate; dihydrocholesteryl octyldecanoate; dihydrocholesteryl oleate; dihydrophytosteryl octyldecanoate; dihydroxyethylamino hydroxypropyl oleate; dihydroxyethyl soyamine dioleate; diisobutyl adipate; diisobutyl oxalate; diisocetyl adipate; diisodecyl adipate; diisopropyl adipate; diisopropyl dimer dilinoleate; diisopropyl oxalate; diisopropyl sebacate; diisostearamidopropyl epoxypropylmonium chloride; diisostearyl adipate; diisostearyl dinner dilinoleate; diisostearyl fumarate; diisostearyl glutarate; diisostearyl malte; dilaureth-7 citrate; dilauryl thiodipropionate; dimethicone copolyol acetate; dimethicone copolyol adipate; dimethicone copolyol almondate; dimethicone copolyol beeswax; dimethicone copolyol behenate; dimethicone copolyol borageate; dimethicone copolyol cocoa butterate; dimethiccne copolyol dhupa butterate; dimethicone copolyol hydroxystearate; dimethicone copolyol isostearate; dimethicone copolyol kokum butterate; dimethicone copolyol lactate; dimethicone copolyol laurate; dimethicone copolyol mango butterate; dimethicone copolyol meadowfoamate; dimethicone copolyol mohwa butterate; dimethicone copolyol octyldodecyl citrate; dimethicone copolyol olivate; dimethicone copolyol sal butterate; dimethicone copolyol shea butterate; dimethicone copolyol stearate; dimethicone copoly undecylenate; dimethiconol beeswax; dimethiconol behenate; dimethiconol borageate; dimethiconol dhupa butterate; dimethiconol fluoroalcohol dillnoleic acid; dimethiconol hydroxystearate; dimethiconol illipe butterate; dimethiconol isostearate; dimethiconol kokum butterate; dimethiconol lactate; di methiconol mohwa butterate; dimethiconol sal butterate; dimethiconol stearate; dimethyl adipate; dimethylaminoethyl methacrylate; dimethyl brassylate; dimethyl cystinate; dimethyl glutarate; dimethyl maleate; dimethyl oxalate; dimethyl succinate; dimyristyl tartrate; dimyristyl thiodipropionate; dinonoxynol-9 citrate; dioctyl adipate; dioctyl butamido triazone; dioctyl dimer dilinoleate; dioctyldodeceth-2 lauroyl glutamate; dioctyldodecyl adipate; dioctyldodecyl dimer dilinoleate; dioctyldodecyl dodecanedioate; dioctyldodecyl fluoroheptyl citrate; dioctyldodecyl lauroyl glutamate; dioctyldodecyl stearoyi dimer dilinoleate; dioctydodecyl stearoyi glutamate; diocty fumarate; dioctyl malate; dioctyl maleate; dioctyl sebacate; dioctyl succinate; dioleoyl edetolmonium methosulfate; dipalmitoyl hydroxyproline; dipentaerythrityl hexacaprylate/hexacaprate; dipentaerythrityl hexaheptanoate/hexacaprylate/hexacaprate; dipentaerythrityl hexahydroxystearate; dipentaerythrityl hexahydroxystearate/stearate/rosinate; dipentaerythrityl hexaoctanoate/behenate; dipentaerythrityl pentahydroxystearate/isostearat-e; dipropyl adipate; dipropylene glycol caprylate; dipropylene dipropyl oxalate; disodium laureth-7 citrate; disodium PEG-5 laurylcitrate sulfosuccinate; disodium PEG-8 ricinosuccinate; disodium succinoyl glycyrrhetinate; disodium 2-sulfolaurate; disteareth-2 lauroyl glutamate; disteareth-5 lauroyl glutamate; distearyl thiodipropionate; ditallowoylethyl hydroxyethylmonium methosulfate; ditridecyl adipate; ditridecyl dinner dilinoleate; ditridecyl thiodipropionate; dodecyl gallate; erucyl arachidate; erucyl erucate; erucyl oleate; ethiodized oil; ethoxydiglycol acetate; ethoxyethanol acetate; ethyl almondate; ethyl apricot kemelate; ethyl arachidonate; ethyl aspartate; ethyl avocadate; ethyl biotinate; ethyl butylacetylaminopropionate; ethyl cyanoacrylate; ethyl cycolhexyl propionate; ethyl digydroxypropyl paba; ethylene brassylate; ethylene carbonate; ethy ester of hydrolyzed animal protein; ethyl ester of hydrolyzed keratin; ethyl ester of hydrolyzed silk; ethyl ester of pvm/ma copolymer; ethyl ferulate; ethyl glutamate; ethyl isostearate; ethyl lactate; ethyl laurate; ethyl linoleate; ethyl linolenate; ethyl niethacrylate; ethyl methylphenylglycidate; ethyl minkate; ethyl morrhuate; ethyl myristate; ethyl nicotinate; ethyl oleate; ethyl olivate; ethyl paba ethyl palmitate; ethylparaben; ethyl pelargonate; ethyl persate; ethyl phenylacetate; ethyl ricinoleate; ethyl serinate; ethyl stearate; ethyl thioglycolate; ethyl urocanate; ethyl wheat germate; ethyl ximenynate; Itocrylene; famesyl acetate; galactonolactone; galbanum (ferula galbaniflua) oil; gamrnma-nonalacione; geranyl acetate; glucarolactone; glucose glutamate; glucose pentaacetate; glucuronolactone; glycereth-7 diisononanoate; glycereth-8 hydroxystearate; glycereth-5 lactate; glycereth-25 PCA isostearate; glycereth-7 triacetate; glyceryl triacetyl hydroxystearate; glyceryl triacetyl ricinoleate; glycolamide stearate; glycol/butylene glycol montanate; glycol catearate; glycol dibehenate; glycol dilaurate; glycol dioctanoate; glycol dioleate; glycol distearate; glycol ditallowate; glycol hydroxystearate; glycol montanate; glycol octanoate; glycol oleate; glycol palmitate; glycol ricinoleate; glycol stearate; glycol stearate SE; glycyrrhetinyl stearate; hexacosyl glycol isostearate; hexanediol beeswax; hexanediol distearate; hexanetriol beeswax; hexyldecyl ester of hydrolyzed collagen; hexyldecyl isostearate; hexyldecyl laurate; hexyldecyl octanoate; hexyldecyl oleate; hexyldecyl palmitate; hexyldecyl stearate; hexyl isostearate; hexyl laurate; hexyl nicotinate; homosalate; hydrogenated castor oil hydroxystearate; hydrogenated castor oil isostearate; hydrogenated castor oil lauirate; hydrogenated castor oil stearate; hydrogenated castor oil triisostearate; hydrogenated methyl abietate; hydrogenated rosin; hydroquinone pea; hydroxycetyl isostearate; hydroxyoctacosanyl hydroxystearate; inositol hexa-pca; iodopropynyl butylcarbamate; isoamyl acetate; isoamyl laurate; isobutylated lanolin oil; isobutyl myristate; isobutyl palmitate; isobutylparaben; isobutyl pelargonate; isobutyl stearate; isobutyl tallowate; isoceteareth-8 stearate; isoceteth-10 stearate; isocetyl behenate; isocetyl isodecanoate; isocetyl isostearate; isocetyl laurate; isocetyl linoleoyl stearate; isocetyl myristate, isocetyl octanoate; isocetyl palmitate; isocetyl stearate; isocetyl stearoyl stearate; isodeceth-2 cocoate; isodecyl citrate; isodecyl cocoate; isodecyl hydroxystearate; isodecyl isononanoale; isodecyl laurate; isodecyl myristate; isodecyl neopentanoate; isodecyl octanoate; isodecyl oleate; isodecyl palmitate; isodecyl paraben; isodecyl stearate; isohexyl laurate; isohexyl neopentanoate; isohexyl palmitate; isolauryl behenate; isomerized jojoba oil; isononyl ferulate; isooctyl thioglycolate; isopropyl arachidate; isopropyl avocadate; isopropyl behenate; isopropyl citrate; isopropyl C12-15-pareth-9 carboxylate; isopropyl hydroxystearate; isopropyl isostearate; isopropyl jojobate; isopropyl lanolate; isopropyl laurate; isopropyl linoleate; isopropyl myristate; isopropyl oleate; isopropylparaben; isopropyl PPG-2-isodeceth-7 carboxylate; isopropyl ricinoleate; isopropyl sorbate; isopropyl stearate; isopropyl tallowate; isopropyl thioglycolate; isosorbide laurate; isosteareth-10 stearate; isostearyl avocadate; isostearyl behenate; isostearyl erucate; isostearyl isononanoate; iscstearyl isostearate; isostearyl isostearoyl stearate; isostearyl lactate; isostearyl laurate; isostearyl myristate; isostearyl neopentanoate; isostearyl octanoate; isostearyl palmitate; isostearyl stearoyl stearate; isotridecyl isononanoate; isotridecyl laurate; isotridecyl myristate; jojoba (buxus chinensis) oil; jojoba esters; kojic dipalmitate; laneth-9 acetate; laneth-10 acetate; laneth-4 phosphate; lanolin linoleate; lanolin ricinoleate; laureth-2 acetate; laureth-6 citrate; laureth-7 citrate; laureth-2 octanoate; laureth-7 tartrate; lauroyl ethyl glucoside; lauroyl lactylic acid; lauryl behenate; lauryl cocoate; lauryl isostearate; lauryl lactate; lauryl methacrylate; lauryl myristate; lauryl octanoate; lauryl oleate; lauryl palmitate; lauryl stearate; linalyl acetate; linoleyl lactate; madecassicoside; mannitan laurate; mannitan oleate; menthyl acetate; menthyl anthranilate; menthyl lactate; menthyl pea; methoxyisopropyl acetate; methoxy-PEG-7 rutinyl succinate; methyl acetyl ricinoleate; methyl anthranilate; methyl behenate; methyl caproate; methyl caprylate; methyl caprylate/caprate; methyl cocoate; 6-methyl coumarin; methyl dehydroabietate; methyl dihydroabietate; methyldihydroj asmonate; methyl glucose dioleate; methyl glucose isostearate; methyl glucose laurale; methyl glucose sesquicaprylate/sesquicaprate; methyl glucose sesquicocoate; methyl glucose sesquiisostearate; methyl glucose sesquilaurate; methyl glucose sesquioleate; methyl glucose sesquistearate; methyl glycyrrhizate; methyl hydrogenated rosinate; methyl hydroxystearate; methyl isostearate; methyl laurate; methyl linoleate; methyl 3-methylresorcylate; methyl myristate; methyl nicotinate; methyl oleate; methyl palmate; methyl palmitate; methylparaben; methyl pelargonate; methyl ricinoleate; methyl rosinate; methyl silanol acetyl methionate; methyl silaiaol carboxymethyl theophylline; methylsilanol carboxymethyl theophylline alginate; methylsilanol hydroxyproline; methylsilanol hydroxyproline aspartate; methylsilanol mannuronate; methylsilanol pea; methyl soyate; methyl stearate; methyl thioglycolate; monosaccharide lactate condensata; myreth-3 caprate; myreth-3 laurate; myreth-2 myristate; myreth-3 myristate; myreth-3 octanoate; myreth-3 palmitate; myristoyl ethyl glucoside; myristoyl lactylic acid; myristyl isostearate; myristyl lactate; myristyl lignocerate; myristyl myristate; myristyl octanoate; myristyl propionate; myristyl stearate; neopentyl glycol dicaprate; neopentyl glycol dicaprylate/dicaprate; neopentyl glycol dicaprylate/dipelargonate/dicaprate; neopentyl glycol diheptanoate; neopentyl glycol diisostearate; neopentyl glycol dilaurate; neopentyl glycol dioctanoate; nonyl acetate; nopyl acetate; octacosanyl glycol isostearate; octocrylene; octyl acetoxystearate; octyl caprylate/caprate; octyl cocoate; octyldecyl oleate; octyldodecyl behenate; octyldodecyl erucate; octyldodecyl hydroxystearate; octyldodecyl isostearate; octyldodecyl lactate; octyldodecyl lanolate; octyldodecyl meadowfoamate; octyldodecyl myristate; octyldodecyl neodecanoate; octyldodecyl neopentanoate; octyldodecyl octanoate; octyldodecyl octyldodecanoate; octyldodecyl oleate; octyldodecyl olivate; octyldodecyl ricinoleate; octyldodecyl stearate; octyldodecyl steroyl stearate; octyl gallate; octyl hydroxystearate; octyl isononanoate; octyl isopalmitate; octyl isostearate; octyl laurate; octyl linoleayl stearate; octyl myristate; octyl neopentanoate; octyl octanoate; octyl oleate; octyl palmitate; octyl PCA; octyl pelagonate; octyl stearate; oleoyl ethyl glucoside; oleyl acetate; oleyl arachidate; oleyl erucate; oleyl ethyl phosphate; oleyl lactate; oleyl lanolate; oleyl linoleate; oleyl myristate; oleyl oleate; oleyl phosphate; oleyl stearate; oryzanol; ozonized jojoba oil; palmitoyl carniline; palmitoyl inulin; palmitoyl myristyl serinate; pantethine; panthenyl ethyl ester acetate; panthenyl triacetate; pea glyceryl oleate; pea palmitate; PEG-18 castor oil dioleate; PEG-5 DMDM hydantoin oleate; PEG-15 dmdm hydantoin stearate; PEG-30 dipolyhydroxystearate; PEG-20 hydrogenated castor oil isostearate; PEG-50 hydrogenated castor oil isostearate; PEG-20 hydrogenated castor oil triisostearate; PEG-20 mannitan laurate; PEG-20 methyl glucose distearate; PEG-80 methyl glucose laurate; PEG-20 methyl glucose sesquicaprylate/sescquicaprate; PEG-20 methyl glucose sesquilaurate; PEG-5 oleamide dioleate; PEG-150 pentaerythrityl tetrastearate; PEG-3/PPG-2 glyceryl/sorbitol hydroxystearate/isostearate; PEG-4 proline linoleate; PEG-4 proline linolenate; PEG-8 propylene glycol cocoate; PEG-55 propylene glycol oleate; PEG-25 propylene glycol stearate; PEG-75 propylene glycol stearate; PEG-120 propylene glycol stearate; PEG40 sorbitol hexaoleate; PEG-50 sorbitol hexaoleate; PEG-30 sorbitol tetraoleate laurate; PEG-60 sorbitol tetrastearate; PEG-5 tricapryl citrate; PEG-5 tricetyl citrate; PEG-5 trilauryl citrate; PEG-5 trimethylolpropane trimyristate; PEG-5 trimyristyl citrate; PEG-5 tristeaiyl citrate; PEG-6 undecylenate; pentadecalacione; pentaerythrityl dioleate; pentaerythrityl di stearate; pentaerythrityl hydrogenated rosinate; pentaerythrityl isostearate/caprate/caprylate/adipate; pentaerythrityl rosinate; pentaerythrityl stearate; pentaerythrityl stearate/caprate/caprylate/adipate; pentaerythrityl stearate/lsostearate/adipate/hydroxystearate; pentaerythrityl tetraabietate; pentaerythrityl tetraacetate; pentaerityl tetrabehenate; petaerythrityl tetracaprylate/tetracaprate; pentaerythrityl tetracocoate; pentaerythrityl tetraisononanoate; pentaerythrityl tetralaurate; pentaerythrityl tetramyristate; pentaerythrityl tetraoctanoate; pentaerythrityl tetraoleate; pentaerythrityl tetrapelargonate; petaerythrityl tetrastearate; pentaerythrityl trioleate; phenoxyethylparaben; phylosteryl macadamiate; potassium butylparaben; potassium deceth-4 phosphate; potassium ethylparaben; potassiuim methylparaben; potassium propylparaben; PPG-2 isoceleth-20 acetate; PPG-14 laureth-60 alkyl dicarbamate; PPG-20 methyl glucose ether acetate; PPG-20 methyl glucose ether distearate; PPG-2 myristyl ether propionate; PPG-14 palmeth-60 alkyl dicarbamate; pregnenolone acetate; propylene glycol alginate; propylene glycol behenate; propylene glycol caprylate; propylene glycol Ceteth-3 acetate; propylene glycol Ceteth-3 propionate; propylene glycol citrate; propylene glycol cocoate; propylene glycol dicaprate; propylene glycol dicaproate; propylene glycol dicaprylate; propylene glycol dicocoate; propylene glycol diisononanoate; propylene glycol diisostearate; propylene glycol dilaurate; propylene glycol dioctanoate; propylene glycol dioleate; propylene glycol dipelargonate; propylene glycol distearate; propylene glycol diundecanoate; propylene glycol hydroxystearate; propylene glycolisoceteth-3 acetate; propylene glycol isostearate; propylene glycol laurate; propylene glycol linoleate; propylene glycol linolenate; propylene glycol myristate; propylene glycol myristyl ether acetate; propylene glycol oleate; propylene glycol oleate se; propylene glycol ricinoleate; propylene glycol soyate; propylene glycol stearate; propylene glycol stearate se; propyl gallate; propylparaben; pyricarbate; pyridoxine dicaprylate; pyridoxine dilaurate; pyridoxine dioctenoate; pyridoxine dipalmitate; pyridoxine glycyrrhetinate; pyridoxine tripalmitate; raffmose myristate; raffinose oleate; resorcinol acetate; retinyl acetate; retinyl linoleate; retinyl palmitate; retinyl propionate; riboflavin tetraacetate; ribonolaclone; siloxanetriol phytate; silybum marianum ethyl ester; sodium behenoyl lactylate; sodium butylparaben; sodium caproyl lactylate; sodiumn cocoyl lactylate; sodium dilaureth-7 citrate; sodium ethylparaben; sodium ethyl 2-sulfolaurate; sodium isostearoyl lactylate; sodium laureth-7 tartrate; sodium lauroyl lectylate; sodium methylparaben; sodium methyl 2-sulfolaurate; sodium oleoyl lactylate; sodium panteheine sulfonate; sodium phytate; sodium propylparaben; sodium stearoyl lactylate; sorbeth-2 cocoate; sorbeth-6 hexastearate; sorbeth-3 isostearate; sorbityl acetate; soybean palmitate; soy sterol acetate; stearamide dea-distearate; stearamide diba-stearate; stearamide mea-stearate; steareth-5 stearate; stearoyl lactylic acid; stearyl acetate; stearyl acetyl glutamate; stearyl beeswax; stearyl behenate; stearyl caprylate; stearyl citrate; stearyl erucate; stearyl glycol isostearate; stearyl glycyrrhetinate; stearyl heptanoate; stearyl lactate; stearyl linoleate; stearyl octanoate; stearyl stearalte; stearyl stearoyl stearate; sucrose cocoate; sucrose dilaurate; sucrose distearate; sucrose laurate; sucrose myristate; sucrose octaacetate; sucrose oleate; sucrose palmitate; sucrose polybehenate; sucrose polycottonseedate; sucrose polylaurate; sucrose polylinoleate; sucrose polypalmate; sucrose polysoyate; sucrose polystearate; sucrose ricinoleate; sucrose stearate; sucrose tetrastearate triacetate; sucrose tribehenate; sucrose tristearate; tallowoyl ethyl glucoside; tannic acid; TEA-lauroyl lactylate; telmesteine; terpineol acetate; tetradecyleicosyl stearate; tetrahexyldecyl ascorbate; tetrahydrofurfuryl ricinoleate; tocophersolan; tocopheryl acetate; tocopheryl linoleate; tocopheryl linoleate/oleate; tocopheryl nicotinate; tocopheryl succinate; tributyl citrate; tri-C12-13 alkyl citrate; tri-C14-15 alkyl citrate; tricaprylyl citrate; tridecyl behenate; tridecyl cocoate; tridec), erucate; tridecyl isononanoate; tridecyl laurate; tridecyl myristate; tridecyl neopentanoate; tfridecyl octanoate; tridecyl stearate; tridecyl stearoyl stearate; tridecyl trimellitate; triethylene glycol hydrogenated rosinate; trihexyldecyl citrate; triisocetyl citrate; triisopropyl trilinoleate; triisostearyl citrate; triisostearyl trilinoleate; trilactin; trilauryl citrate; trimethylol propane tricaprylate/tricaprate; trimethylolpropane tricocoate; trimethylolpropane trilaurate; trimethylalpropane trioctanoate; trimethylolpropane tristearate; trimethyl pentanyl diisobutyrate; trioctyl citrate; trioctyldodecyl borate; trictyl trimellitate; trioleyl citrate; tripaba panthenol; tripropylene glycol citrate; tristearyl citrate; tristearyl phosphate; and yeast palmitate.

In a preferred embodiment, the ester oils are natural product oils that are typically found in animal or plant tissues, including those which have been hydrogenated to eliminate or reduce unsaturation. These natural product oils that can be employed in the present invention include compounds that have the following formula:

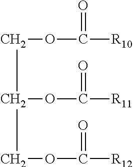

where R₁₀, R₁₁ and R₁₂ may be the same or different fatty acid radicals containing from 8 to 22 carbon atoms.

Suitable natural product oils of the above formula that can be employed in the present invention include, but are not limited to: Kernel Oil; Argania Spinosa Oil; Argemone Mexicana Oil; Avocado (Persea Gratissima) Oil; Babassu (Orbignya Olelfera) Oil; Balm Mint (Melissa Officinalis) Seed Oil; Bitter Almond (Prunus Amygdalus Amara) Oil; Bitter Cherry (Prunus Cerasus) Oil; Black Currant (Ribes Nigrrrm) Oil; Borage (Borago Officinalis) Seed Oil; Brazil (Bertholletia Excelsa) Nut Oil; Burdock (Arctium Lappa) Seed Oil; Butter; C12-18 Acid Triglyceride; Calophyllurn tacamahaca Oil; Camellia kissi Oil; Camellia oleifera Seed Oil; Canola Oil; Caprylic/Capric/Liuric Triglyceride; Caprylic/Capric/Linoleic Triglyceride; Caprylic/Capric/Myristic/Stearic Triglyceride; Caprylic/Capric/Stearic Triglyceride; Caprylic/Capric Triglyceride; Caraway (Canimn Carvi) Seed Oil; Carrot (Daucus Carota Sativa) Oil; Cashew (Anacardium Occidentale) Nut Oil; Castor (Ricinus Communis) Oil; Cephalins; Chaulmoogra (Taraktogenos Kurzii) Oil, Chia (Salvia Hispanica) Oil; Cocoa (Theobrama Cocao) Butter; Coconut (Cocos Nucifera) Oil; Cod Liver Oil; Coffee (Coffea Arabica) Oil; Corn (Zea Mays) Germ Oil; Corn (Zea Mays) Oil; Cottonseed (Gossypium) Oil; C10-18 Triglycerides; Cucumber (Cucumis Sativus) Oil; Dog Rose (Rosa Canina) Hips Oil; Egg Oil; Emu Oil; Epoxidized Soybean Oil; Evening Primrose (Oenothera Biennis) Oil; Fish Liver Oil; Gevuina Avellana Oil; Glyceryl Triacetyl Hydroxystearate; Glyceryl Triacetyl Ricinoleate; Glycolipids; Glycosphingolipids; Goat Butter; Grape (Vitis Vinifera) Seed Oil; Hazel (Croylus americana) Nut Oil; Hazel (Corylus Aveilana) Nut Oil; Human Placental Lipids; Hybrid Safflower (Ceathamus tinctorius) Oil; Hybrid Sunflower (Helianthus Annuus) Seed Oil; Hydrogenated Canola Oil; Hydrogenated Castor Oil; Hydrogenated Castor Oil Laurate; Hydrogenated Castor Oil Triisostearate; Hydrogenated Coconut Oil; Hydrogenated Cottonseed Oil; Hydrogenated C12-18 Triglycerides; Hydrogenated Fish Oil; Hydrogenated Lard; Hydrogenated Menhaden Oil; Hydrogenated Milk Lipids; Hydrogenated Mink Oil; Hydrogenated Olive Oil; Hydrogenated Orange Roughy Oil; Hydrogenated Palm Kernel Oil; Hydrogenated Palm Oil; Hydrogenated Peanut Oil; Hydrogenated Rapeseed Oil; Hydrogenated Shark Liver Oil; Hydrogenated Soybean Oil; Hydrogenated Tallow; Hydrogenated Vegetable Oil; Isatis Tinctoria Oil; Job's Tears (Coix Lacryma-jobi) Oil; Jojoba Oil; Kiwi (Actinidia Chinensis) Seed Oil; Kukui (Aleurites moluccana) Nut Oil; Lard; Lauric/Palmitic/Oleic Triglyceride; Linseed (Linum usitatissimum) Oil; Lupin (Lupinus Albus) Oil; Macadamia Nut Oil; Macadamia Ternifolia Seed Oil; Macadamia Integrifolia Seed Oil; Maleated Soybean Oil; Mango (Mangifera Indica) Seed Oil; Marmot Oil; Meadowfoam (Limnanthes fragraAlba) Seed Oil; Menhaden Oil; Milk Lipids; Mink Oil; Moringa Pterygosperma Oil; Mortierella Oil; Musk Rose (Rosa Moschata) Seed Oil; Neatsfoot Oil; Neem (Melia Azadirachta) Seed Oil; Oat (Avena Sativa) Kernel Oil; Oleic/Linoleic Triglyceride; Oleic/Palmitic/Lauric/Myristic/L-inoleic Triglyceride; Oleostearine; Olive (Olea Europaea) Husk Oil; Olive (Olea Europaea) Oil; Omental Lipdis; Orange Roughy Oil; Ostrich Oil; Oxidized Corn Oil; Palm (Elaeis Guineensis) Kernel Oil; Palm (Elaeis Guineensis) Oil; Passionflower (Passiflora Edulis) Oil; Peach (Prunus Persica) Kernel Oil; Peanut (Arachis Hypogaea) Oil; Pecan (Caiya illinoensis) Oil; Pengawar Djambi (Cibotium barometz) Oil; Phospholipids; Pistachio (Pistacia Vera) Nut Oil; Placental Lipids; Poppy (Papaver Orientale) Oil; Pumpkin (Cucurbita Pepo) Seed Oil; Quinoa (Chenopodium Quinoa) Oil; Rapeseed (Brassica Campestris) Oil; Rice (Oryza Sativa) Bran Oil; Rice (Oryza Sativa) Germ Oil; Safflower (Carthamus tinctorius) Oil; Salmon Oil; Sandalwood (Santalum album) Seed Oil; Seabuchthom (Hippophae rhamnoides) Oil; Sesame (Sesamum Indicum) Oil; Shark Liver Oil; Shea Butter (Butyrospermum parkii); Silk Worm Lipids; Skin Lipids; Soybean (Glycine Soja) Oil; Soybean Lipid; Sphingolipids; Sunflower (Helianthus Annuus) Seed Oil; Sweet Almond (Prunus Amygdalus Dulcis) Oil; Sweet Cherry (Prunus Avium) Pit Oil; Tali Oil; Tallow; Tea Tree (Melaleuca Altemifolia) Oil; Telphairia Pedata Oil; Tomato (Solanum Lycopersicum) Oil; Triarachidin; Tiibehenin; Tricaprin; Tricaprylin; Trichodesma Zeylanicum Oil; Trierucin; Triheptanoin; Triheptylundecanoin; Trihydroxymethoxystearin; Trihydroxystearin; Triisononanoin; Triisopalmitin; Triisostearin; Trilaurin; Trilinolein; Trilinolenin; Trimyristin; Trioctanoin; Triolein; Tripalmitin; Tripalmitolein; Triricinolein; Trisebacin; Tristearin; Triundecanoin; Tuna Oil; Vegetable Oil; Walnut (Juglans Regia) Oil; Wheat Bran Lipids; and Wheat (Triticum Vulgare) Germ Oil. In some preferred embodiments, the natural oil product is one or more of soybean oil, coconut oil, rapeseed oil, high oleic acid sunflower oil or olive oil. The oils of the present invention may be partially or fully hydrogenated.

The amount of softener or ester, preferably biorenewable ester-containing oils, present in the thermoplastic elastomer compositions of the present invention can vary depending upon the types of polymers utilized and end products desired to be formed with the compositions. That said, in one embodiment, the amount of softener, preferably biorenewable, utilized in the thermoplastic elastomer compositions ranges generally from about 5 to about 400 parts, desirably from about 50 to about 250 parts, and preferably from about 75 or 100 to about 200 parts by weight based on 100 total parts by weight of total styrenic block copolymer. In another embodiment wherein the styrenic block copolymer comprises at least one styrenic block copolymer including a controlled distribution block including a conjugated diene and a mono alkenylarene, the softener or ester, preferably biorenewable, ranges in an amount generally from about 1 to about 85 parts, desirably from about 5 to about 75 parts, and preferably from about 10 to 65 about parts by weight based on 100 total parts by weight of the composition.

Still additional softeners or extenders include fatty ethers, fatty alcohols and fatty amines. Said components, individually, can be utilized in amounts set forth for the softeners or esters hereinabove.

Fatty Ethers

Fatty ethers are utilized in some compositions of the present invention. Fatty ethers having the general formula R13-O—R14, can be utilized wherein R13 contains from about 6 to about 34 carbon atoms and preferably from about 10 to about 22 carbon atoms, and R₁₄ contains from about 1 to about 22 carbon atoms and preferably from about 4 to about 22 carbon atoms. The fatty ethers can be linear or branched.

Fatty Alcohols

Fatty alcohols are utilized in some compositions of the present invention. Fatty alcohols having the general formula R₁₅—OH, can be utilized wherein R₁₅ contains from about 6 to about 34 carbon atoms and preferably from about 13 to about 34 carbon atoms. Examples of fatty alcohols include, but are not limited to 1-hexanol, 1-heptanol, 1-octanol, 1-nonanol, 1-decanol, 1-undecanol, 1-dodecanol, 1-tridecanol, 1-tetradecanol, 1-pentadecanol, 1-hexadecanol, 1-heptadecanol, 1-octadecanol, 1-nonadecanol, 1-eicosanol, 1-heneicosanol, 1-docosanol, 1-tricosanol, 1-tetracosanol, 1-pentacosanol, 1-hexacosanol, 1-heptacosanol, 1-octasanol, 1-nonacosanol, 1-tricontanol, 1-hentriacontanol, 1-dotriacontanol, 1-tritriacontanol, and 1-tetratriacontanol. In one embodiment, at least one fatty alcohol utilized includes saturation and branching. The fatty alcohols can be linear or branched, for example Guerbet alcohols.

Fatty Amines

Fatty amines are utilized in some compositions of the present invention. Fatty amines can be utilized having the general formula:

R16-N—(R₁₇)—R₁₈

wherein each R₆, R₇ and R-₈, independently, is hydrogen, or contains from about 4 to about 34 carbon atoms and preferably from about 10 to about 22 carbon atoms, with the proviso that at least one said R is not hydrogen. Examples of suitable fatty amines include, but are not limited to, amines derived from fatty acids, for example, dimethyl stearamine, stearyl amine, and oleyl amine. In one embodiment at least one fatty amine utilized includes saturation and branching. The fatty amines can be linear or branched.

Synergistic Additives, Preferably Biorenewable

As indicated hereinabove, the compositions of the present invention also include a synergistic additive that is believed to create greater stability within the thermoplastic elastomer compositions. Some biorenewable synergistic additives are polar components in various embodiments. The polar synergistic additive can provide higher surface energy, one or more of better oil retention at room temperature and at higher temperatures and in some embodiments, lower compression set, greater tensile strength, tensile modulus at various percentages, tensile elongation and tear strength when compared to a corresponding composition without the additive. The thermoplastic elastomer compositions of the present invention can be processed in standard processing equipment such as injection molders and extruders.

A number of different biorenewable synergistic additives can be utilized in combination with the biorenewable softeners of the present invention. For example, additives include, but are not limited to, starches; thermoplastic starches; and biorenewable polar polymers such as aliphatic polyesters, e.g. polylactic acids and polylactides.

Starch

In one embodiment, starches and/or starch-containing components are utilized as a biorenewable synergistic additive. Starch-containing components as utilized herein refer to a composition comprising at least starch and preferably a dispersion aid, for example glycerin. For example, in one embodiment of a dry blend process, if starch is used, a dispersion aid such as glycerin is added to provide desired dispersion of the starch in the blend.

The term “starch” as utilized herein refers to any starch of natural origin whether processed, chemically modified, or treated. Suitable starches comprise corn starch, potato starch, amaranth starch, arrowroot starch, banana starch, barley starch, cassava starch, millet starch, oat starch, pea starch, rice starch, rye starch, sago starch, sorghum starch, sweet potato starch, tapioca starch, wheat starch, and yam starch.

The effective plasticizer or dispersion aid helps swell and break the crystalline starch granule, and helps lubricate newly exfoliated, amorphous crystalline starch segments to obtain the thermoplastic starch. Heat and shear further aids in the starch gelatinization process. The plasticizer or dispersion aid can include polyols, such as glycerol, sorbitol etc., adipic acid derivatives, such as tridecyl adipate, benzoic acid derivatives, such as isodecyl benzoate, citric acid derivatives, such as tributyl citrate, glycerol derivatives, phosphoric acid derivatives, such as tributyl phosphate, polyesters, sebacic acid derivatives, dimethyl sebacate, urea. The plasticizer or dispersion aid can also be selected from one or more of glycerine, ethylene glycol, propylene glycol, ethylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylol propane, pantaerythritol, and the acetate, ethoxylate, and propoxylate derivatives thereof. Moreover, the plasticizer or dispersion aid can be selected from one or more of sorbitol ethoxylate, glycerol ethoxylate, pentaerythritol ethoxylate, sorbitol acetate, and pentaerythritol acetate.

Starches and starch-containing components provide improved softener stability. In various embodiments with other biorenewable components, for example PLA, compositions having desired hardness ranges can be achieved. Starches and starch-containing components further increase bio-renewable content of the compositions in addition to the biorenewable content of the compositions derived from the softener or plasticizer, without significant deterioration of the mechanical properties of the compositions.

Starch includes modified starches, such as chemically treated and cross-linked starches, and starches in which the hydroxyl groups have been substituted with organic acids, to provide esters or with organic alcohols to provide ethers, with degrees of substitution in the range 0-3.

Starch also includes extended starches, such as those extended with proteins; for example with soya protein.

Thermoplastic Starch

The biorenewable additives of the present invention also include thermoplastic starches. Thermoplastic starches offer the advantages of the capability of flow and are thus suitable for use in polymer processing methods and equipment. Thermoplastic starches are available from various commercial sources in compounded form. In various embodiments, thermoplastic starches are prepared and used simultaneously in a compounding process to form compositions of the present invention. Methods of preparing thermoplastic starch are disclosed in U.S. Pat. No. 6,605,657. In various embodiments of the present invention a dry blended mixture of elastomer such as styrenic block copolymer, thermoplastic and softener together with other processing additives are fed through an extruder. The mixture is then melt mixed with the thermoplastic starch in the remaining downstream portion of the extruder. There are two extruders involved in this operation. The two are connected in a “T” shape.

When present in compositions of the present invention, the total starch, one or more of starch and thermoplastic starch, is in an amount from about 2 to about 40 or 80, desirably from about 2 to about 60 and preferably from 2 to about 40 parts by weight based on 100 total parts by weight of the composition. When utilized, the dispersion aid is present in an amount from about 1 to about 80, desirably from about 2 to about 60 and preferably from 2 to about 50 parts by weight based on 100 parts of the starch.

Polar Polymer

The biorenewable synergistic additives also include polar polymers such as aliphatic polyesters. Examples of suitable aliphatic polyesters include polylactic acids, and polylactides [PLAs], poly(glycolic acids) and polyglycolides [PGAs], poly (lactic-co-glycolic), and poly(lactide-co-glycolide) [PLGA], polyglyconate, poly(hydroxyalkanoates) [PHAs], polyorthoesters [POEs], polycaprolactones [PCLs], polydioxanone [PDS], polyanhydrides [PANs], polyether-block-amide (PEBA), and their copolymers.

The polar polymers are provided in amounts which impart desirable properties to the thermoplastic elastomer compositions of the invention, and, when present, generally range in an amount from about 0.1 or 1 to about 80 parts, desirably from about 2 to about 60 parts, and preferably from about 2 or 3 to about 20 or 40 parts based on 100 total parts by weight of the composition of the present invention.

Polyolefins

In one embodiment, the compositions of the present invention optionally include one or more polyolefins, which as utilized herein are defined as one or more of a polyolefin polymer and a polyolefin copolymer unless otherwise indicated. Polyolefins suitable for use in the compositions of the present invention comprise amorphous or crystalline homopolymers or copolymers of two or more same or different monomers derived from alpha-monoolefins having from 2 to about 12 carbon atoms, and preferably from 2 to about 8 carbon atoms. Examples of suitable olefins include ethylene, propylene, 1-butene, 1-pentene, 1-hexene, 2-methyl-1-propene, 3-methyl-1-pentene, 4-methyl-1-pentene, 5-methyl-1-hexene, and combinations thereof. Polyolefins include, but are not limited to, low-density polyethylene, high-density polyethylene, linear-low-density polyethylene, polypropylene (isotactic and syndiotactic), ethylene/propylene copolymers, and polybutene. Polyolefin copolymers can also include the greater part by weight of one or more olefin monomers and a lesser amount of one or more non-olefin monomers such as vinyl monomers including vinyl acetate, or a diene monomer, etc. Polar polyolefin polymers include ethylene acrylate and ethylene vinyl acetate, for example. In a preferred embodiment, EVA is utilized that has a vinyl acetate content of greater than 5 percent. Generally, a polyolefin copolymer includes less than 40 weight percent of a non-olefin monomer, desirably less than 35 weight percent, and preferably less than about 30 weight percent of a non-olefin monomer.

In a further embodiment, the polyolefin can include at least one functional group per chain or can be a blend of non-functionalized polyolefins and functionalized polyolefins. Functional groups can be incorporated into the polyolefin by the inclusion of for example, one or more non-olefin monomers during polymerization of the polyolefin. Examples of functional groups include, but are not limited to, anhydride groups such as maleic anhydride, itaconic anhydride and citraconic anhydride; acrylates such as glycidyl methacrylate; acid groups such as fumaric acid, itaconic acid, citraconic acid and acrylic acid; epoxy functional groups; and amine functional groups. Functional group-containing polyolefins and methods for forming the same are well known to those of ordinary skill in the art. Functionalized polyolefins are available commercially from sources such as Uniroyal, Atofina, and DuPont. Epoxy modified polyethylenes are available from Atofina as LOTADER®. Acid modified polyethylenes are available from DuPont as FUSABOND®.

Polyolefin polymers and copolymers are commercially available from sources including, but not limited to, Chevron, Dow Chemical, DuPont, ExxonMobil, Huntsman Polymers, Ticona and Westlake Polymer under various designations.

When present, the polyolefins range in an amount generally from about 0.5 to about 60 parts, desirably from about 0.5 or 2 to about 30 or 50 parts, and preferably from about 0.5 to about 20 or 40 parts by weight based on 100 total parts by weight of the total composition.

Additives

The compositions of the present invention may include additional additives including, but not limited to lubricants, light stabilizers, antioxidant, flame retardant additives, pigments, peroxides, heat stabilizers, processing aids, mold release agents, flow enhancing agents, nanoparticles, foam agents, platelet fillers and non-platelet fillers. Examples of fillers for use in the compositions include, but are not limited to, one or more of calcium carbonate, talc, clay, zeolite, silica, titanium dioxide, carbon black, barium sulfate, mica, glass fibers, whiskers, carbon fibers, magnesium carbonate, glass powders, metal powders, kaolin, graphite, and molybdenum disulfide. Suitable fillers include bio-based fillers, e.g. various fibers, cellulose, and/or lignin.

Other Polymers

In various embodiments, other polymers can be added to the compositions of the present invention in an assortment of amounts provided that such polymers do not interfere with the desired performance of the compositions and constructions formed therewith. Examples of additional polymers include, but are not limited to, polyamide such as nylon, acrylonitrile-butadiene-styrene copolymers (ABS), halogenated polymers such as polyvinyl chloride, polycarbonates, acrylic polymers, PET, PBT, TPU (including TPU with a bio based polyester block), polyether-block-amide (PEBA).

The high biorenewable content thermoplastic elastomer compositions of the present invention can be formed by blending the desired components in one or more steps, preferably by mixing. The composition is preferably heated to obtain a melted composition, preferably with mixing, to substantially disperse the components thereof. Melt blending is performed at a temperature generally from about 150° C. to about 250° C. and preferably from about 170° C. to about 210° C. The compositions can be prepared for example in a Banbury, on a two roll mill, in a continuous mixer such as a single screw or twin screw extruder, a kneader, or any other mixing machine as known to those of ordinary skill in the art. The compositions containing thermoplastic starch are prepared in a one step process using combination of single screw extruder connected midway to a twin screw extruder. The process is described in detail in U.S. Pat. No. 6,844,380. After preparation of the compositions, they can be pelletized or diced utilizing appropriate equipment, if desired for future further processing. Alternatively, the compositions can be directly molded, or shaped as desired for example using an extruder, injection molder, compression molder, calender, or the like.

As described herein, desirable compositions can be formed utilizing the teachings of the present invention which exhibit high oil stability; low oil softener or ester leaching; or low oil, etc., bleeding. Oil stability or the like is defined in one embodiment according to the present invention utilizing a loop spew test as defined with the examples section. Desirable compositions according to the present invention have a loop spew rating of 2 or less, desirably 1 or less, and preferably 0, that is no visible evidence of oil on the loop surface.

The compositions of the present invention can be utilized to form a variety of articles or parts of articles such as, but not limited to, shaving razors, toothbrushes, writing utensils such as pens or pencils, brushes such as paint brushes and hair brushes, hair dryers, tools, for example screwdrivers, hammers, wrenches, pliers and saws, kitchen appliances, for example handles for refrigerators, ovens, microwaves, dishwashers, kitchen utensils, such as spoons, forks, knives, spatulas, can openers, bottle openers, corkscrews, whisks and vegetable peelers, vacuum cleaner handles, brooms, mops, rakes, shovels, scissors, sporting equipment, such as fishing poles, firearms, tennis rackets, and golf clubs, bracelets for example for absorbing sweat, various seals including automotive weather seals, wine corks, and window encapsulation. The thermoplastic elastomer compositions of the invention can also be coated on fabric, such as making wet grip gloves, non-skid fabrics, etc.

The compositions of the present invention may be formed as a composite with a different substrate for example by connecting the composition of the present invention to the substrate utilizing any desired method, for example overmolding, insert molding, coextrusion, welding or bonding with an adhesive. Overmolding generally involves bonding the thermoplastic elastomer composition to a polymeric substrate utilizing a two-shot or multi-shot injection molding process or a co-injection molding process. Overmolding generally includes providing two or more different materials that are injected into the same mold during the same molding cycle. Insert molding generally comprises inserting pre-molded or pre-formed substrate into a mold and the composition of the present invention is molded directly over or to at least a portion of the insert.

In addition, the thermoplastic elastomeric compositions may comprise up to about 2 wt. %, preferably up to about 1 wt. % anti-oxidant, more preferably up to about 0.5% wt. % antioxidant. Suitable anti-oxidant may include hindered phenols, thiol compounds, amines or phosphites. The suitable anti-oxidant may also come from renewable source.

The thermoplastic elastomeric compositions also may comprise up to about 3 wt. % colorant. Suitable color pigments are known to those skilled in the art and the exact amount of color pigment is readily empirically determined based on the desired color characteristic of the composition and the finished product. The suitable colorant may also contain renewable sourced content or recycled content.

The thermoplastic elastomeric compositions may also comprise up to about 3 wt. %, preferably about 1 wt. %, of a processing aid such a metal stearate, soaps, an ultra-high molecular weight siloxane polymer or lubricants, in order to assist proper flow of the polymer melt through the injection molded barrel and dies and result in molded parts with good surface characteristics. A suitable example is zinc stearate and the suitable processing aid may also contain renewable sourced content.

The thermoplastic elastomeric compositions may also optionally comprise stabilizers, such as heat stabilizer and/or light stabilizer, such as ultraviolet light stabilizers, as well as combinations of heat and light stabilizers. Heat stabilizers, like antioxidants, include phenolics, amines, phosphites, and the like, as well as combinations comprising at least one of the foregoing heat stabilizers. Light stabilizers include low molecular weight (having number-average molecular weights less than about 1,000 AMU) benzophenones or hindered amines, high molecular weight (having number-average molecular weights greater than about 1,000 AMU) hindered amines, benzotriazoles, hydroxyphenyl triazines, and the like, as well as combinations comprising at least one of the foregoing light stabilizers. Optionally, various additives known in the art may be used as needed to impart various properties to the composition, such as heat stability, stability upon exposure to ultraviolet wavelength radiation, long-term durability, and processability. The exact amount of stabilizer is readily empirically determined by the reaction employed and the desired characteristics of the finished article, with up to about 3 wt. % possible, 1 wt. % preferred. The suitable light stabilizer may also contain renewable sourced content.

The thermoplastic elastomeric compositions and articles formed thereof may be prepared in a process. In the present process, the polymer blend comprised of a thermoplastic elastomer material, such as styrene-ethylene-butadiene-styrene (SEBS) polymer in powder form, is pre-mixed with polyethylene, anti-oxidant, and oil using a high shear mixer or other such device to form a tumble mixed blend of the composition prior to being disposed into the hopper of the twin screw extruder, through which the premix is melted, mixed and pelletized in to thermoplastic elastomer pellets. The formed Thermoplastic elastomer can be processed into different products such as wine corks, toothpicks and others by extrusion process, injection molding and other polymer processing processes.

### EXPERIMENTAL DETAILS

Mixing in a continuous process typically occurs in a twin-screw extruder that was elevated to a temperature that was sufficient to melt the polymer matrix with addition of all additives at the feed-throat, or by injection or side-feeders downstream. Extruder speeds ranged from about 50 to about 1200 revolutions per minute (rpm), and preferably from about 300 to about 700 rpm, for example. Typically, the output from the extruder was pelletized for later processing. By the use of a twin-screw extruder, the blending components as shown hereunder were kneaded at from about 160° C. to about 220° C., and extruded into strands, which were then cut into pellets. For example, a lab twin screw extruder included 9 zones, with zone 1 about 160° C., zone 2 about 180° C., zone 3 about 210° C., zone 4 about 210° C., zone 5 about 200° C., zone 6 about 180° C., zone 7 about 160° C., zone 8 about 160° C., zone 9 about 160° C. The pelletizer temperature may be 170° C.

### Examples 1-4

A composition of pellet form was prepared in accordance with the compounding recipe shown in Table 1, using a twin-screw extruder under conditions discussed in experiment details. The pellets were injection-molded to prepare a square sheet of 10 cm×10 cm. The sheet was cut by a dumbbell cutter to prepare test pieces for measurement. In the preparation of the composition in the twin-screw extruder, Components were dry-blended; the blend was passed through the extruder. The results are shown in Table 2.

As is clear from Table 2, the Elastomer Compositions of this embodiment are elastomers having a low compression set, excellent elasticity and excellent dynamic properties.

TABLE 1
Raw

| Material | 231A | | 231B | | 231C | | 1A | |
|---|---|---|---|---|---|---|---|---|
| Name | pphr | % | pphr | % | pphr | % | phbr | % |
| SEBS 1633 | 100.00 | 31.50 | 100.00 | 31.50 | 100.00 | 30.35 | 100.00 | 32.00 |
| Drakeol 600 | 121.00 | 38.12 | 121.00 | 38.21 | 121.00 | 36.73 | 121.00 | 38.72 |
| Polypropylene | 23.00 | 7.25 | 0.00 | 0.00 | 0.00 | 0.00 | 0.00 | 0.00 |
| 6523 | | | | | | | | |
| Polypropylene | 0.00 | 0.00 | 23.00 | 7.25 | 0.00 | 0.00 | 0.00 | 0.00 |
| Inspire 114 | | | | | | | | |
| Polyastolyn | 10.00 | 3.15 | 10.00 | 3.15 | 10.00 | 3.04 | 10.00 | 3.20 |
| 290 | | | | | | | | |
| LLDPE | 23.00 | 7.25 | 23.00 | 7.25 | 58.00 | 17.61 | 0.00 | 0.00 |
| SP4030 | | | | | | | | |
| Armoslip E | 0.25 | 0.08 | 0.25 | 0.08 | 0.25 | 0.08 | 0.25 | 0.08 |
| Irogonox | 0.20 | 0.06 | 0.20 | 0.06 | 0.20 | 0.06 | 0.21 | 0.07 |
| 1010 | | | | | | | | |
| Vicron | 40.00 | 12.00 | 40.00 | 12.60 | 40.00 | 12.14 | 40.00 | 12.80 |
| 25-11 | | | | | | | | |
| Polypropylene | 0.00 | 0.00 | 0.00 | 0.00 | 0.00 | 0.00 | 41.00 | 13.12 |
| CP360H | | | | | | | | |
| TOTAL | 317.45 | 100.00 | 317.45 | 100.00 | 329.45 | 100.00 | 312.46 | 100.00 |
| Density | 0.990 | | 1.008 | | 0.997 | | 0.982 | |
| (gram/cm²) | | | | | | | | |

TABLE 2
Group 14A, 14B, 14C, 1A test result summary

| | 14A | 14B | 14C | 1A |
|---|---|---|---|---|
| Hardness, Shore A | 61 | 62 | 64 | 60 |
| Density, g/cm³ | 0.98 | 0.99 | 0.99 | 0.98 |
| Compression Set, | 34.41% | 36.34% | 29.15% | 41.01% |
| 70° C. @ 22 hrs | | | | |
| Tensile Strength, MPa | 5.70 | 5.31 | 6.01 | 8.19 |
| Tensile Elongation, % | 436 | 288 | 142 | 571 |
| 100% Modulus, MPa | 2.89 | 3.63 | 4.87 | 2.66 |
| 300% Modulus, MPa | 4.46 | — | — | 4.24 |
| Viscosity(200° C.) @ Shear | 1095.24 | 1168.71 | 1464.54 | 653.70 |
| Rate 67 1/S, Pa*s | | | | |

### Examples 5-9

A composition of pellet form was prepared in accordance with the compounding recipe shown in Table 3, using a twin screw extruder under conditions discussed in experiment details. The pellets were injection-molded to prepare a square sheet of 10 cmx 10 cm. The sheet was cut by a dumbbell cutter to prepare test pieces for measurement. In the preparation of the composition in the twin screw extruder, Components were dry-blended; the blend was passed through the extruder. The results are shown in Table 4.

As is clear from Table 4, the Elastomer Compositions of this embodiment are elastomers having a low compression sets, excellent elasticity and good melt strength.

TABLE 3
Raw

| material | A | | B | | C | | D | | E | |
|---|---|---|---|---|---|---|---|---|---|---|
| Name | pphr | % | pphr | % | pphr | % | phbr | % | phbr | % |
| SEBS 503T | 100.00 | 35.57 | 100.00 | 35.57 | 100.00 | 35.57 | 100.00 | 35.57 | 100.00 | 35.57 |
| Drakeol 34 | 121.00 | 43.04 | 121.00 | 43.04 | 121.00 | 43.04 | 121.00 | 4304 | 121.00 | 43.04 |
| LLDPE | 30.00 | 10.67 | 15.00 | 5.34 | 0.00 | 0.00 | 45.00 | 16.01 | 60.00 | 21.34 |
| SP4030 | | | | | | | | | | |
| PP6523 | 30.00 | 10.67 | 45.00 | 16.01 | 60.00 | 21.34 | 15.00 | 5.34 | 0.00 | 0.00 |
| BNX1010 | 0.14 | 0.05 | 0.14 | 0.05 | 0.14 | 0.15 | 0.14 | 0.05 | 0.14 | 0.05 |
| TOTAL | 281.14 | 100.00 | 281.14 | 100.00 | 281.14 | 100.00 | 281.14 | 100.00 | 281.14 | 100.00 |

TABLE 4
Group A, B, C, D, E test result summary

| | A | B | C | D | E |
|---|---|---|---|---|---|
| Hardness, Shore A | 69 | 73 | 77 | 63 | 61 |
| Density, g/cm³ | 0.88 | 0.88 | 0.88 | 0.91 | 0.91 |
| Compression Set, | 45.1% | 48% | 54.7% | 38.4% | 34% |
| 70° C. @ 22 hours | | | | | |
| Compression Set, | 18.2% | 18.8% | 22.1% | 15% | 12.7% |
| 23° C. @ 22 hours | | | | | |
| Tensile | | | | | |
| Tensile Strength, MPa | 5.60 | 5.65 | 7.10 | 6.36 | 6.38 |
| Tensile Elongation, % | 374 | 228 | 349 | 498 | 477 |
| 50% Modulus, MPa | 3.10 | 3.95 | 4.59 | 2.09 | 1.50 |
| 100% Modulus, MPa | 3.81 | 4.70 | 5.28 | 2.68 | 2.16 |
| 200% Modulus, MPa | 4.60 | 5.42 | 5.99 | 3.56 | 3.30 |
| 300% Modulus, MPa | 5.19 | 5.93 | 6.51 | 4.39 | 4.36 |
| Rheology | | | | | |
| Viscosity(200° C.) @ | 810.32 | 695.22 | 575.73 | 916.81 | 1064.23 |
| Shear Rate 67 1/S, Pa*s | | | | | |

### Examples 10-15

A composition of pellet form was prepared in accordance with the compounding recipe shown in Table 5, using a twin screw extruder under conditions discussed in experiment details. The pellets were injection-molded to prepare a square sheet of 10 cmx 10 cm. The sheet was cut by a dumbbell cutter to prepare test pieces for measurement. In the preparation of the composition in the twin screw extruder, Components were dry-blended; the blend was passed through the extruder. The results are shown in Table 6.

As is clear from Table 6, the Elastomer Compositions of this embodiment are elastomers having a low hardness, compression sets, excellent elasticity, and good melt strength.

TABLE 5
Raw

| Material | 177A | | 177B | | 177C | |
|---|---|---|---|---|---|---|
| Name | pphr | % | pphr | % | pphr | % |
| SEBS 1633 | 0.00 | 0.00 | 0.00 | 0.00 | 0.00 | 0.00 |
| SEBS 1651 | 100.00 | 43.49 | 100.00 | 40.01 | 100.00 | 42.56 |
| Drakeol 600 | 110.00 | 47.84 | 110.00 | 44.01 | 100.00 | 42.56 |
| Polypropylene | 8.00 | 3.48 | 18.00 | 720 | 16.00 | 6.81 |
| Inspire 114 | | | | | | |
| PP 6523 | | | | | | |
| Alathon ®HDPE | 8.00 | 3.48 | 18.00 | 7.20 | 16.00 | 6.81 |
| H5618 | | | | | | |
| Irgonox 1010 | 0.15 | 0.07 | 0.15 | 0.06 | 0.15 | 0.06 |
| BNX 1010 | | | | | | |
| Armoslip E | 0.50 | 0.22 | 0.50 | 0.20 | 0.50 | 0.21 |
| BNX DLTDP | 0.30 | 0.13 | 0.30 | 0.12 | 0.30 | 1.28 |
| MB50 002 | 3.00 | 1.30 | 3.00 | 1.20 | 3.00 | 1.28 |
| Silicone | | | | | | |
| MASTERBATCH | | | | | | |

Raw

| Material | 177D | | 178A | | 178B | |
|---|---|---|---|---|---|---|
| Name | phbr | % | phbr | % | ppbr | % |
| SEBS 1633 | 100.00 | 40.01 | | | | |
| SEBS 1651 | 0.00 | 0.00 | 100.00 | 39.69 | 100.00 | 37.32 |
| Drakeol 600 | 110.00 | 44.01 | 110.00 | 43.66 | 116.00 | 43.29 |
| Polypropylene | 18.00 | 7.20 | | | | |
| Inspire 114 | | | | | | |
| PP 6523 | | | 19.00 | 7.54 | 24.00 | 8.96 |
| Alathon ®HDPE | 18.00 | 7.20 | 19.00 | 7.54 | 0.00 | 0.00 |
| H5618 | | | | | | |
| Irgonox 1010 | 0.15 | 0.06 | | | | |
| BNX 1010 | | | 0.15 | 0.06 | 0.15 | 0.06 |
| Armoslip E | 0.50 | 0.20 | 0.50 | 0.20 | 0.20 | 0.19 |
| BNX DLTDP | 3.00 | 1.20 | 0.30 | 0.12 | 0.30 | 0.11 |
| MB50 002 | 3.00 | 1.20 | 3.00 | 1.19 | 3.00 | |
| Silicone | | | | | | |
| MASTERBATCH | | | | | | |

TABLE 6

| | Hardness, | Compression | testing | |
|---|---|---|---|---|
| No. | Shore A | Set | condition | Protocol |
| 177A | 41 | 41.8 | 70° C., 22 h | ASTM D359B |
| 177B | 58 | 38 | 70° C., 22 h | ASTM D359B |
| 177C | 58 | 40.1 | 70° C., 22 h | ASTM D359B |
| 177D | 59 | 35.7 | 70° C., 22 h | ASTM D359B |
| 178A | 58 | 46.2 | 70° C., 22 h | ASTM D359B |
| 178B | 60 | 45 | 70° C., 22 h | ASTM D359B |

### Examples 16-20

A composition of pellet form was prepared in accordance with the compounding recipe shown in Table 8, using a twin-screw extruder under conditions discussed in experiment details. The pellets were injection-molded to prepare a square sheet of 10 cm×10 cm. The sheet was cut by a dumbbell cutter to prepare test pieces for measurement. In the preparation of the composition in the twin-screw extruder, Components were dry-blended; the blend was passed through the extruder. The results are shown in Table 9.

Table 7 shows the source of ingredients for examples 16-20 of the present invention. Table 8 shows the formulation and table 9 shows the test results of the formulations.

TABLE 7
Ingridients

| | | Commercial | Sustainable |
|---|---|---|---|
| Name | Type | Source | Status |
| SEBS G1633 | Hydrogenated | Kraton, Houston, | Fossil based |
| | SBC | TX | |
| SEBS R1651 | Hydrogenated | Kraton, Houston, | Renewable |
| | SBC | TX | Sourced |
| Drakeol 600 | Mineral Oil | Calumet, | Fossil based |
| | | Indianapolis, IN | |
| Pionier TP 130 N | Bio-based oil | H&R, Germany | Plant based |
| Pionier TP 130 | Bio-based oil | H&R, Germany | Plant based |
| NTW | | | |
| Polypropylene | Polypropylene | Braskem, | Fossil Based |
| Inspire 114 | | Philadelphia, PA | |
| LLDPE SP4030 | LLDPE | Prime Polymers, | Fossil Based |
| | | Japan | |
| SPB 681 | LDPE | Braskem, Brazil | Plant Based |
| Armoslip E | ERUCAMIDE | PMC Biogenix, | Plant based |
| | | Memphis, TN | |
| Iroganox 1010 | hindered | BASF, Florham | Fossil Based |
| | primary | Park, New Jersey | |
| | phenolic | | |
| | antioxidant | | |
| Vicron 25-11 | Calcium | Specialty Minerals, | |
| | Carbonate | Adams, | |
| | | Massachusetts | |
| OceanCal 3S | Biogenic | Calcean Minerals | Renewable |
| | Calcium | & Materials, | and |
| | Carbonate | Gadsden, AL | sustainable |
| Elvax 460 | Ethylene-vinyl | Dow Chemical, | Fossil Based |
| | acetate | Midland, MI | |
| Talcron MP | Talc | Specialty Minerals, | Fossil Based |
| 15-38 | | Adams, | |
| | | Massachusetts | |

As is clear from Table 8 and 9, the Elastomer Compositions of this embodiment are elastomers having a low compression set, excellent elasticity and excellent dynamic properties. The bio and sustainable content of the recipes ranges from 37.64% to 90.53%.

TABLE 8
Examples 16-20.

Raw

| Material | 1 | | 2 | | 3 | | 4 | | 5 | |
|---|---|---|---|---|---|---|---|---|---|---|
| Name | pphr | % | pphr | % | pphr | % | pphr | % | pphr | % |
| SEBS 1633 | 100.00 | 31.11 | 100.00 | 31.11 | 100.00 | 31.11 | 100.00 | 31.11 | 0.00 | 0.00 |
| SEBS R1651 | 0.00 | 0.00 | 0.00 | 0.00 | 0.00 | 0.00 | 0.00 | 0.00 | 100.00 | 31.11 |
| Drakeol 600 | 121.00 | 37.64 | 0.00 | 0.00 | 0.00 | 0.00 | 0.00 | 0.00 | 0.00 | 0.00 |
| Pionier TP | 0.00 | 0.00 | 121.00 | 37.64 | 0.00 | 0.00 | 0.00 | 0.00 | 0.00 | 0.00 |
| 130N | | | | | | | | | | |
| Pionier TP | 0.00 | 0.00 | 0.00 | 0.00 | 121.00 | 37.64 | 121.00 | 37.64 | 121.00 | 37.64 |
| 130NTW | | | | | | | | | | |
| Polypropylene | 30.00 | 9.33 | 30.00 | 9.33 | 30.00 | 9.33 | 30.00 | 9.33 | 30.00 | 9.33 |
| Inspire 114 | | | | | | | | | | |
| LLDPE | 30.00 | 9.33 | 30.00 | 9.33 | 30.00 | 9.33 | 0.00 | 0.00 | 0.00 | 0.00 |
| SP4030 | | | | | | | | | | |
| SPB 681 | 0.00 | 0.00 | 0.00 | 0.00 | 0.00 | 0.00 | 30.00 | 9.33 | 30.00 | 9.33 |
| Armoslip E | 0.25 | 0.08 | 0.25 | 0.08 | 0.25 | 0.08 | 0.25 | 0.08 | 0.25 | 0.08 |
| Irganox 1010 | 0.20 | 0.06 | 0.20 | 0.06 | 0.20 | 0.06 | 0.20 | 0.06 | 0.20 | 0.06 |
| Vircon 25-11 | 40.00 | 12.44 | 40.00 | 12.44 | 40.00 | 12.44 | 0.00 | 0.00 | 0.00 | 0.00 |
| OceanCal 3S | 0.00 | 0.00 | 0.00 | 0.00 | 0.00 | 0.00 | 40.00 | 12.44 | 40.00 | 12.44 |
| Total | 321.45 | 100.00 | 321.45 | 100.00 | 321.45 | 100.00 | 321.45 | 100.00 | 321.45 | 100.00 |

TABLE 9
Example 16-20 test result summary

| | 1 | 2 | 3 | 4 | 5 |
|---|---|---|---|---|---|
| Hardness, Shore A | 65 | 60 | 67 | 62 | 61 |
| Density, g/cm³ | 0.98 | 0.97 | 0.95 | 0.95 | 0.95 |
| Compression Set, | 37.41% | 47.54% | 38.15% | 39.01% | 39.6% |
| 70° C. @ 22 hrs | | | | | |
| Tensile Strength, MPa | 5.80 | 4.63 | 5.41 | 4.34 | 4.67 |
| Tensile Elongation, % | 518 | 368 | 393 | 218 | 234 |
| 100% Modulus, MPa | 3.27 | 2.66 | 3.49 | 3.31 | 3.47 |
| 300% Modulus, MPa | 4.65 | 4.05 | 4.82 | — | — |
| Viscosity(200° C.) @ Shear | 759.70 | 770.73 | 613.57 | 574.62 | 567.35 |
| Rate 67 1/s, Pa*s | | | | | |

### Examples 21-23

Another set of compositions of pellet form were prepared in accordance with the compounding recipes shown in Table 10, using a twin-screw extruder under conditions discussed in experiment details. The pellets were injection-molded to prepare a square sheet of 10 cm×10 cm. The sheet was cut by a dumbbell cutter to prepare test pieces for measurement. In the preparation of the composition in the twin-screw extruder, Components were dry-blended; the blend was passed through the extruder. The results are shown in Table 11.

TABLE 10
Raw

| material | 6 | | 7 | | 8 | |
|---|---|---|---|---|---|---|
| Name | pphr | % | pphr | % | pphr | % |
| SEBS 1651 | 100.00 | 35.57 | 100.00 | 32.64 | 100.00 | 32.64 |
| Drakeol 600 | 121.00 | 43.00 | 121.00 | 39.49 | 121.00 | 39.49 |
| Elvax 460 | 0.00 | 0.00 | 0.00 | 0.00 | 30.00 | 9.79 |
| Isnpsire 114 | 30.00 | 10.66 | 30.00 | 9.79 | 0.00 | 0.00 |
| SP4030 | 30.00 | 10.66 | 30.00 | 9.79 | 30.00 | 9.79 |
| Irganox 1010 | 0.16 | 0.06 | 0.17 | 0.06 | 0.17 | 0.06 |
| MP 15-38 | 0.00 | 0.00 | 25.00 | 8.16 | 25.00 | 8.16 |
| Armoslip E | 0.22 | 0.08 | 0.24 | 0.08 | 0.24 | 0.08 |
| Total | 281.38 | 100.00 | 306.41 | 100.00 | 306.41 | 100.00 |

TABLE 11

| | 6 | 7 | 8 |
|---|---|---|---|
| Hardness, Shore A | 65 | 69 | 53 |
| Density, g/cm³ | 0.89 | 0.94 | 0.95 |
| Compression Set, | 21.6% | 20.3% | 15.0% |
| 23° C. @ 22 hrs | | | |
| Compression Set, | 41.5% | 40.0% | 38.2% |
| 70° C. @ 22 hrs | | | |
| Dyne Level | 34 | 32-34 | 40 |
| Ink Adhesion/Printability | Good | Good | Excellent |
| Tensile | | | |
| Tensile Strength, MPa | 5.37 | 5.66 | 4.12 |
| Tensile Elongation, % | 441 | 442 | 393 |
| 50% Modulus, MPa | 2.35 | 2.66 | 1.10 |
| 100% Modulus, MPa | 2.94 | 3.27 | 1.65 |
| 200% Modulus, MPa | 3.70 | 4.04 | 2.56 |
| 300% Modulus, MPa | 4.38 | 4.72 | 3.40 |
| Rheology | | | |
| Viscosity(200° C.) @ Shear | 738.32 | 820.12 | 839.49 |
| Rate 67 1/s, Pa*s | | | |

As is well known, a compound's surface energy can be measured in dyne level. The unit of measurement of Surface Energy is Dyne/cm² this can also be expressed in mN/m. Dyne=Unit of force equal to the force that imparts an acceleration of 1 cm/sec/sec to a mass of 1 gram. 1 Dyne=0.00001 Newtons. The more surface energy or higher the dyne level a surface has, the better an adhesive (ink) will adhere to it. It is clear from this set of experiments, adding a carefully chosen polar compound can significantly increase the surface energy and improve the compound's ink adhesion.

The embodiments of the present compositions, processes and articles made there from, although primarily described in relation to wine cork skin application, may be utilized in numerous other applications, both nonautomotive and automotive vehicle applications such as interior sheathing, including instrument panel skins, door panels, air bag covers, roof liners, and seat covers,

It will be understood that a person skilled in the art may make modifications to the embodiments shown herein within the scope and intent of the claims. While the present invention has been described as carried out in specific embodiments thereof, it is not intended to be limited thereby but is intended to cover the invention broadly within the scope of the claims.

The above-cited patents and patent publications are hereby incorporated by reference in their entirety. Although various embodiments have been described with reference to a particular arrangement of parts, features, and like, these are not intended to exhaust all possible arrangements or features, and indeed many other embodiments, modifications, and variations may be ascertainable to those of skill in the art. Thus, it is to be understood that the invention may therefore be practiced otherwise than as specifically described above.

We claim:

1. A thermoplastic elastomer composition, comprising,
a polymer blend comprising from a non-crosslinked elastomer;
from about 15 wt. % to about 50 wt. % softener;
from about 3.0 wt. % to about 30 wt. % polyethylene; and
from about 3.0 wt. % to about 15 wt. % a polar polymer.

2. The thermoplastic elastomer composition of claim 1 further comprises a filler.

3. The thermoplastic elastomer composition of claim 1, wherein the non-cross-linked elastomer comprises styrenic block copolymer.

4. The thermoplastic elastomer composition of claim 3, wherein the styrenic block copolymer is selected from a group consisting of styrene-butadiene-styrene polymer (SBS), styrene-ethylene butylene-styrene (SEBS), styrene-isoprene-styrene (SIS), styrene-isoprene-butadiene-styrene (SIBS), styrene-ethylene propylene-styrene (SEPS), styrene-ethylene propylene (SEP) block copolymer, styrene-ethylene ethylene propylene-styrene (SEEPS), hydrogenated polybutadiene, hydrogenated polyisoprene, hydrogenated styrene-isoprene random copolymer, poly (styrene-[(butadiene)₁₋ₓ-(ethylene-co-butylene)x}-styrene), wherein x is the hydrogenated fraction of the molecule, and hydrogenated styrene-butylene random copolymer.

5. The thermoplastic elastomer composition of claim 4, wherein the styrenic block copolymer comprises styrene-ethylene-butylene-styrene polymer.

6. The thermoplastic elastomer composition of claim 5, wherein the styrenic block copolymer comprises about 20 wt. % to about 50 wt. % styrene-ethylene-butylene-styrene polymer.

7. The thermoplastic elastomer composition of claim 1, wherein the polyethylene comprises linear low density polyethylene (LLDPE).

8. A thermoplastic elastomer composition, comprising,
a polymer blend comprising:
styrenic block copolymer;
from about 15 wt. % to about 50 wt. % softener;
from about 5 wt. % to about 30 wt. % polyethylene; and
from about 3.0 to about 20 wt. % filler, wherein the thermoplastic elastomer has melt viscosity at shear rate of 67 1/s of about 200 to about 2000 measured at about 200° C.

9. The thermoplastic elastomer composition of claim 8, further comprising from about 3.0 wt. % to about 15 wt. % a polar polymer.

10. The thermoplastic elastomer composition of claim 8, wherein the thermoplastic elastomer has a weight percent ratio of non-crosslinked elastomer to softener, when present, from about 0.4 to about 2.5.

11. The thermoplastic elastomer composition of claim 8, wherein the weight percent ratio is from about 0.7 to about 1.5.

12. The thermoplastic elastomer composition of claim 8, the styrenic block copolymer is selected from a group consisting of styrene-butadiene-styrene polymer (SBS), styrene-ethylene butylene-styrene (SEBS), styrene-isoprene-styrene (SIS), styrene-isoprene-butadiene-styrene (SIBS), styrene-ethylene propylene-styrene (SEPS), styrene-ethylene propylene (SEP) block copolymer, styrene-ethylene ethylene propylene-styrene (SEEPS), hydrogenated polybutadiene, hydrogenated polyisoprene, hydrogenated styrene-isoprene random copolymer, poly (styrene-[(butadiene)₁₋ₓ-(ethylene-co-butylene)x}-styrene), wherein x is the hydrogenated fraction of the molecule, and hydrogenated styrene-butylene random copolymer.

13. The thermoplastic elastomer composition of claim 12, wherein the styrenic block copolymer comprises styrene-ethylene-butylene-styrene polymer.

14. The thermoplastic elastomer composition of claim 13, wherein the styrenic block copolymer comprises about 20 wt. % to about 50 wt. % styrene-ethylene-butylene-styrene polymer.

15. A thermoplastic elastomer composition, comprising,
a polymer blend comprising at least one bio based component of:
a styrenic block copolymer, wherein the styrenic block copolymer is selected from a group consisting of styrene-butadiene-styrene polymer (SBS), styrene-ethylene butylene-styrene (SEBS), styrene-isoprene-styrene (SIS), styrene-isoprene-butadiene-styrene (SIBS), styrene-ethylene propylene-styrene (SEPS), styrene-ethylene propylene (SEP) block copolymer, styrene-ethylene ethylene propylene-styrene (SEEPS), hydrogenated polybutadiene, hydrogenated polyisoprene, hydrogenated styrene-isoprene random copolymer, poly (styrene-[(butadiene)₁₋ₓ-(ethylene-co-butylene)x}-styrene), wherein x is the hydrogenated fraction of the molecule, and hydrogenated styrene-butylene random copolymer;
from about 15 wt. % to about 50 wt. % softener;
from about 3 wt. % to about 30 wt. % polyethylene; and
from about 3.0 wt. % to about 15 wt. % a polar polymer, wherein the thermoplastic elastomer has a weight percent ratio of styrenic block copolymer to softener, when present, from about 0.4 to about 2.5.

16. The thermoplastic elastomer composition of claim 15, wherein the styrenic block copolymer comprises styrene-ethylene-butylene-styrene polymer.

17. The thermoplastic elastomer composition of claim 15, wherein the styrenic block copolymer comprises about 25 wt. % to about 50 wt. % styrene-ethylene-butylene-styrene polymer.

18. The thermoplastic elastomer composition of claim 15, wherein the polyethylene comprises linear low density polyethylene (LLDPE).

19. The thermoplastic elastomer composition of claim 15, wherein the thermoplastic elastomer has a weight percent ratio of styrenic block copolymer to softener, when present, of from about 0.4 to about 2.5.

20. The thermoplastic elastomer composition of claim 15, wherein the polar polymer is at least one of ethylene-vinyl acetate, ethylene methyl acrylate copolymer, ethylene Acrylics (EAA)/Methacrylic Acids (EMAA).
